(19) United States
(12) Patent Application Publication
(10) Pub. No.: US 2011/0242056 A1
(43) Pub. Date: Oct. 6, 2011

(54) Optical Recognition User Input Device And Method Of Recognizing Input From User

(75) Inventors: Joong Ho Lee, Seoul (KR); Ji Hyung Park, Seoul (KR); Ki Won Yeom, Gyeonggi-do (KR)

(73) Assignee: KOREA INSTITUTE OF SCIENCE AND TECHNOLOGY, Seoul (KR)

(21) Appl. No.: 13/125,553

(22) PCT Filed: Dec. 30, 2008
(86) PCT No.: PCT/KR08/07810

§ 371 Date: Jun. 21, 2011

(30) Foreign Application Priority Data
Oct. 2, 2008 (KR) 10-2008-0097418

(51) Int. Cl. G06F 3/042

(52) U.S. Cl. 345/175

(57) ABSTRACT

Disclosed is an optical recognition user input device and method for recognizing user input that can prevent an error in recognition of plural touch points. A plurality of optical transmission/reception modules (T/R) are disposed around a touch panel including a plurality of pixels. Each of the optical T/R modules includes a light emitting unit and a light receiving unit. A controller controls operation of the optical T/R modules and calculates a user touch location on the touch panel based on an optical signal received by the light receiving unit.

### TECHNICAL FIELD

The present invention generally relates to an optical recognition device, and more particularly to an optical recognition user input device and a method of recognizing user input (touch point) that can prevent a recognition error when a plurality of touch points are present.

### BACKGROUND ART

Referring to FIG. 1, a plurality of infrared (IR) light emitting units 11, 13 and a plurality of IR light receiving units 12, 14 are arranged around a panel 10 to face each other at upper and lower sides or right and left sides of the panel 10. The IR light emitting units 11, 13 and the IR light receiving units 12, 14 are sequentially turned on/off. The corresponding (facing) IR light emitting and receiving units are turned on/off simultaneously. When IR light is emitted from a certain IR light emitting unit, the corresponding IR light receiving unit detects the IR light, so that it is determined whether a touch point is present between the IR light emitting unit and the IR light receiving unit.

Referring to FIG. 2, in recognition a single touch point with the IR emitting and receiving units of FIG. 1, IR light is sequentially emitted from the IR light emitting units 11a to 11t, arranged in the x-axis direction, and from the IR light emitting units 13a to 13n, arranged in the y-axis direction. It is determined whether the light receiving units 12a to 12t and 14a to 14n receive the IR light emitted from the corresponding IR light emitting units 11a to 11t and 13a to 13n. If there is an obstacle (a touch point) between the IR light emitting units and the IR light receiving units facing each other, i.e., corresponding to each other, the IR light emitted from the light emitting unit does not reach the corresponding light receiving unit. For example, if a touch point TP is present in IR light paths from the IR light emitting units 11f and 11g to the IR light receiving units 12f and 12g located at x₆ and x₇ and from the IR light emitting units 13e and 13g to the IR light receiving units 14e to 14f located at y₅ and y₆, IR light emitted from the IR light emitting units 11f, 11g, 13e and 13f is not received by the light receiving units 12f, 12g, 14e and 14f. As a result, the touch point TP is recognized as being present at (x₆˜x₇, y₅˜y₆).

Such a conventional device and method for infrared light recognition may not have much difficulty in recognizing a single touch point, but causes error in recognizing a plurality of touch points. For example, a non-touched region is recognized as a touch point.

As shown in FIGS. 3 and 4, assuming that two touch points TP1 and TP2 are on the IR touch screen, that is, touch points exist at a region (x₆˜x₇, y₅˜y₆) and another region (x₁₅˜x₁₆, y₉˜y₁₀). However, when recognizing the two touch points TP1 and TP2, four touch points are recognized as being present at four regions ((x₆˜x₇, y₅˜y₆), (x₆˜x₇, y₉˜y₁₀), (x₁₅˜x₁₆, y₅˜y₆), and (x₁₅˜x₁₆, y₉˜y₁₀)). Among these four regions, only the two regions (x₆˜x₇, y₅˜y₆) and (x₁₅˜x₁₆, y₉˜y₁₀) have the actual two touch points TP1 and TP2. However, it is erroneously recognized that other regions (x₆˜x₇, y₉˜y₁₀) and (x₁₅˜x₁₆, y₅˜y₆) also have the touch points, even if the regions are not touched by a user. If there are three actual touch points on the IR touch screen, the conventional device erroneously recognizes that there are six touch points are present. As such, in the conventional technique that recognizes presence of the touch point by using the IR light emitting units and the IR light receiving units facing each other at the opposite sides of the panel, recognition of the multiple touch points is not completely accurate.

Referring to FIG. 5, in another conventional device for recognizing a touch point, a plurality of light receiving units simultaneously receive IR light emitted from a single IR light emitting unit located opposite the light receiving units. Information of existence or non-existence of a touch point on each pixel is saved as bit information. This device has a problem in that the reception intensity of the IR light at the respective IR light receiving units varies depending on differences in distances and angles between the IR light emitting unit and the respective IR light receiving units.

Referring to FIG. 6, when IR light emitted from a certain light emitting unit is received by the IR light receiving units opposite the light emitting unit, in the device of FIG. 5, the intensity of the IR light varies according to the relative location between the respective IR light IR receiving units and the light emitting unit.

Since each of the light receiving units has a fixed critical intensity, only a signal having the critical intensity or more can be detected as a receiving signal and a signal less than the critical intensity cannot be detected as the receiving signal. Thus, it is difficult to accurately determine whether the signal is received by the light receiving units, since a new critical intensity suitable for the respective light reception units should be set by taking into account a positional variation of the light emitting units whenever the light emitting units are sequentially changed.

### DISCLOSURE OF INVENTION

### Technical Problem

The present invention is conceived to solve the problems of the conventional techniques as described above, and an aspect of the present invention is to provide an optical recognition user input device and method of recognizing user input that can prevent a recognition error when a plurality of touch points are present.

### Advantageous Effects

According to the present invention, error in recognition of a touch point (obstacle) can be prevented by enabling plural optical transmission/reception (T/R) modules, corresponding to edge pixels of a panel of an optical recognition user input device, one by one. Each of the optical T/R modules has a light emitting unit and a light receiving unit overlapping each other in an up and down direction. In the recognition, any pixels determined as not having been touched is removed from interest, and location of a touch point may be determined only with remaining pixels when all of the optical T/R modules complete light emission.

### BRIEF DESCRIPTION OF THE DRAWINGS

FIG. 1 is a schematic view of an arrangement of infrared (IR) transmission/reception (T/R) modules of a conventional IR touch screen in which light emitting units and light receiving units have a one-to-one correspondence.

FIG. 2 is a schematic view of single touch point recognition with the IR T/R module of FIG. 1.

FIGS. 3 and 4 illustrate an example of multiple-touch point recognition with the IR T/R module of FIG. 1.

FIG. 5 is a schematic view of a conventional optical recognition user input device in which a plurality of light receiving units receives light emitted from a single light emitting unit.

FIG. 6 is a diagram illustrating variation in signal intensity depending on a relative location between the light receiving units and the light emitting unit.

FIG. 7 is an exemplary diagram showing a perspective view of an integrated optical T/R module according to one embodiment of the present invention.

FIG. 8 is an exemplary diagram illustrating an arrangement of optical T/R modules of the present invention.

FIG. 9 is an exemplary diagram illustrating an arrangement of optical T/R modules of the present invention.

FIGS. 10 to 12 are exemplary diagrams showing recognition of user input device.

FIG. 13 is a circuit diagram of a plurality of optical T/R modules.

FIG. 14 is an exemplary diagram showing signal input/output of a controller for controlling the plurality of integrated optical T/R modules.

FIG. 15 is an exemplary diagram showing a partial configuration of a light emission controller for creating a light emission signal with a supply power Vcc.

FIG. 16 is an operational amplification circuit diagram of a light reception signal.

FIGS. 17 and 18 are exemplary diagrams showing a method of recognizing an obstacle in the present invention.

FIGS. 19 to 21 are exemplary diagrams showing data update of a pixel touch information table.

FIG. 22 is an exemplary diagram showing one example of obstacle recognition using the updated pixel touch information table of FIG. 21.

FIG. 23 is a table showing optical T/R modules for light emission and candidates of optical T/R modules for light reception corresponding thereto.

FIG. 24 is an exemplary diagram showing an optical recognition user input device.

FIG. 25 is a flowchart of a method of recognizing user input (touch point).

FIG. 26 is a flowchart of a method of recognizing user input (touch point).

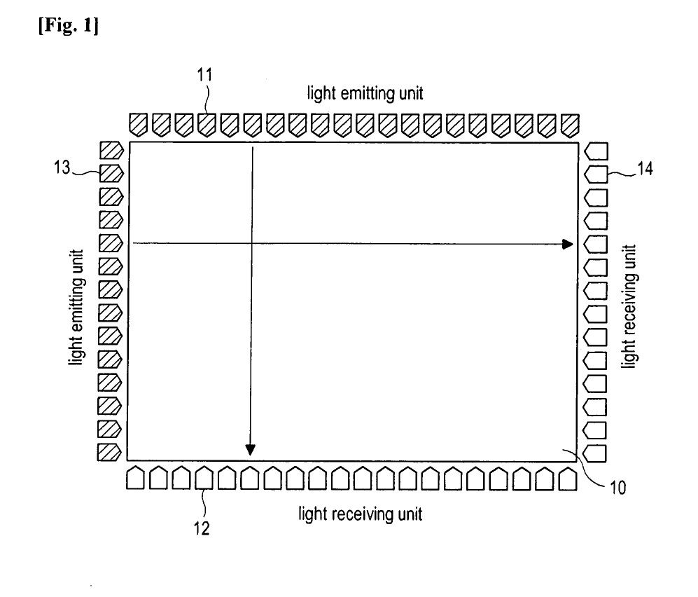

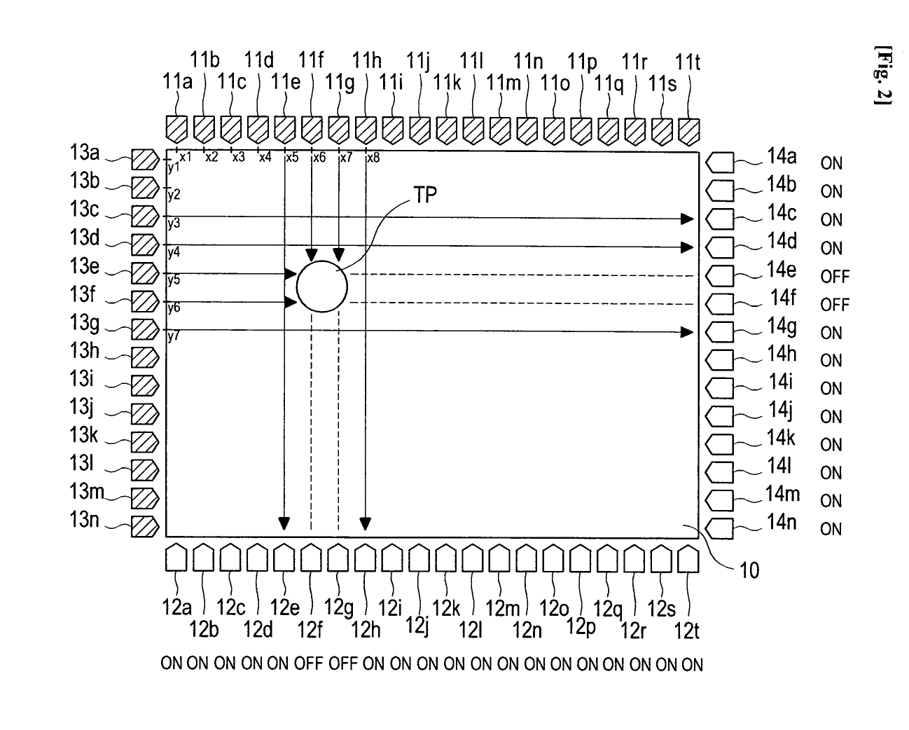

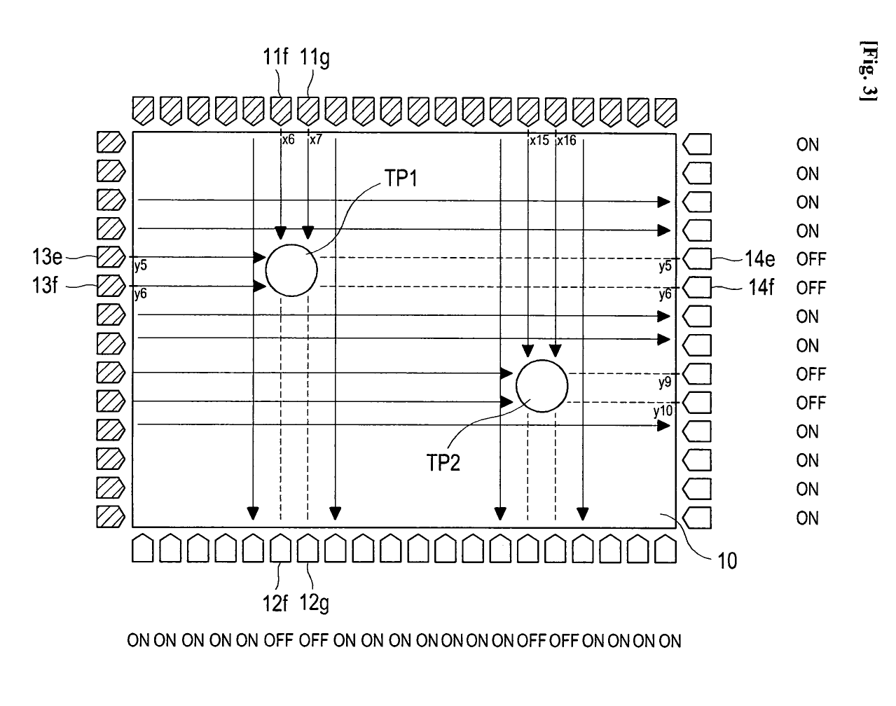

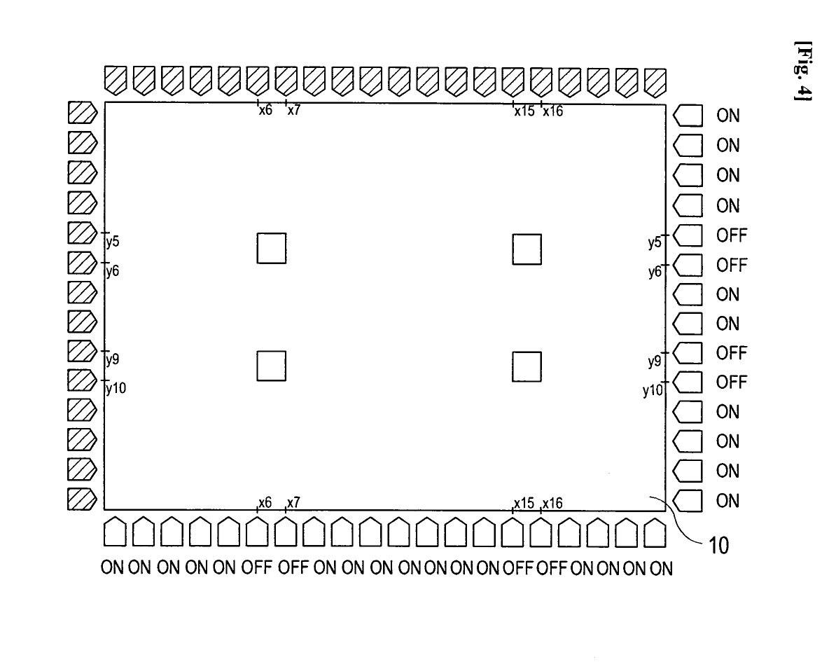

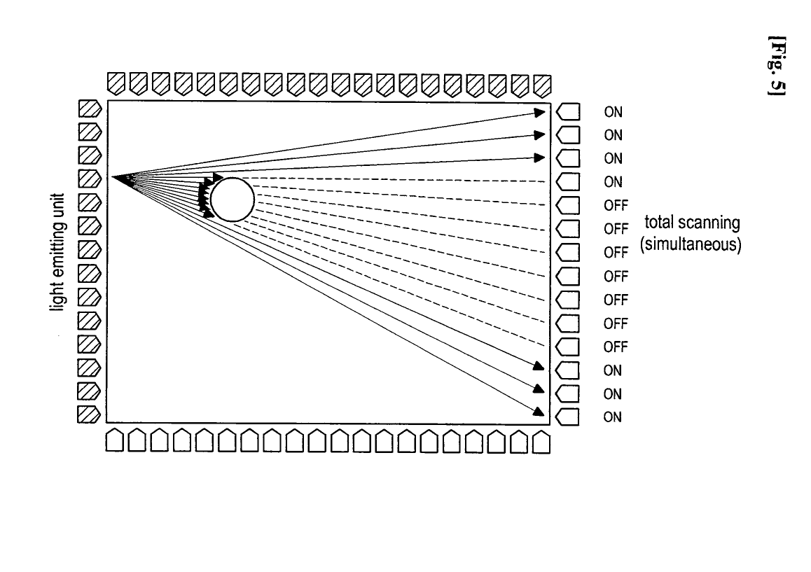

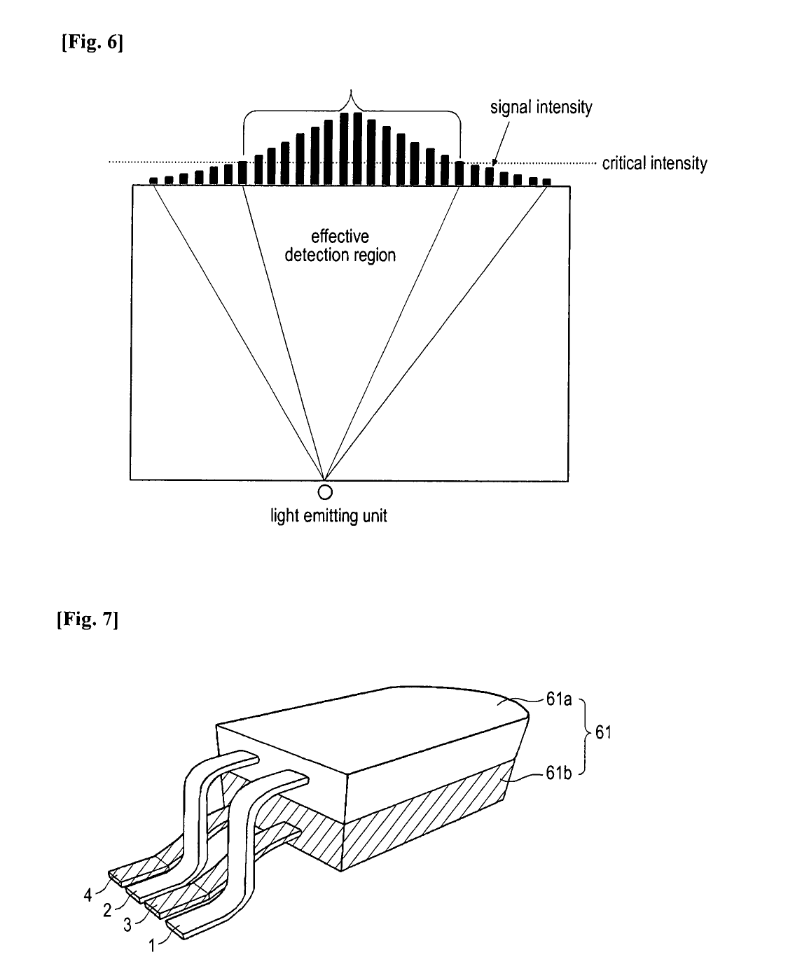

### BEST MODE FOR CARRYING OUT THE INVENTION

In accordance with one aspect of the present invention, there is provided an optical recognition user input device including a touch panel including a plurality of pixels; a plurality of optical transmission/reception (T/R) modules disposed around the touch panel, wherein each of the optical T/R modules includes a light emitting unit and a light receiving unit; and a controller configured to control operation of the plurality of optical T/R modules and to calculate a user touch location on the touch panel based on an optical signal received by the light receiving unit.

In accordance with another aspect of the present invention, there is provided an optical recognition user input device including a touch panel comprising a plurality of pixels; and a plurality of optical T/R modules disposed around the touch panel, wherein each of the optical T/R modules includes a light emitting unit and a light receiving unit, the light emitting unit and the light receiving unit of each of the optical T/R modules being overlapped each other in an up and down direction and operated independently of each other.

In accordance with a further aspect of the present invention, there is provided a method of recognizing user input using an optical recognition device comprising light emitting units and light receiving units, the method including controlling the light emitting units in sequence or in a predetermined pattern, and controlling operation of the light receiving units corresponding to the light emitting units; and calculating a user input location based on receiving signals sent from the light receiving units.

In accordance with yet another aspect of the present invention, there is provided a method of recognizing user input using an optical recognition device comprising light emitting units and light receiving units, the method including setting information of respective pixels of a touch panel receiving the user input to an initial value; changing the information of the respective pixels of the touch panel based on input signals from the light receiving units of the optical recognition device; and calculating a user input location based on the information of the respective pixels of the touch panel.

### MODE FOR THE INVENTION

Exemplary embodiments of the present invention will be described in detail with reference to the accompanying drawings hereinafter. Components having the same operation and functions will be indicated by the same reference numerals throughout the drawings.

Referring to FIG. 7, an integrated optical transmission/reception (T/R) module 61, according to one embodiment of the present invention, includes a light emitting unit 61a and a light receiving unit 61b overlapping each other in an up and down direction. The light emitting unit 61a is disposed on the light receiving unit 61b, thereby forming a stacked structure. The light emitting unit 61a and the light receiving unit 61b are operated independently of each other. The light emitting unit 61a has data lines 1 and 2, to which a light emission enable signal and a light emission signal are respectively input. The light emitting unit 61a is enabled in response to the light emission enable signal and may output light—an optical signal to an outside. The light receiving unit 61b has a data line 3, to which a light reception enables signal input. The light receiving unit 61b may output a light reception signal to a data line 4 in response to the optical signal. In one embodiment of the invention, the light emitting unit 61a and the light receiving unit 61b may share a power line.

The light emitting unit 61a may be configured with a light emitting diode (LED), and the light receiving unit 61b may be configured with a photo diode (PD). The light emitting unit 61a and the light receiving unit 61b may transmit and receive light in the infrared wavelength range. However, it should be noted that the light emitting unit 61a and the light receiving unit 61b are not limited thereto and that the kind of diode and the wavelength of the light can be determined according to applications of the optical recognition user input device.

Although the light emitting unit 61a is shown as being disposed on the light receiving unit 61b, in FIG. 7, the light emitting unit 61a may be disposed under the light receiving unit 61b. The light emitting unit 61a and the light receiving unit 61b of the optical T/R module 61 may be formed to overlap each other within an injection molded housing so as to constitute an integrated and stacked structure.

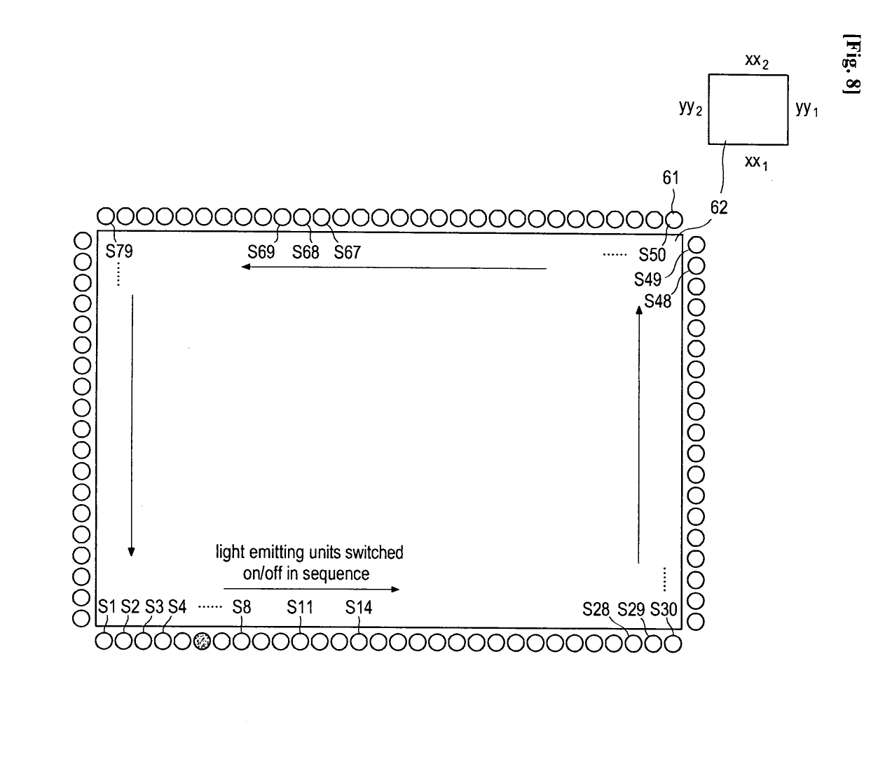

FIG. 8 shows an arrangement of optical T/R modules disposed around a touch panel 62 according to one embodiment of the present invention. In one embodiment, the touch panel 62 may be a transparent film or plate configured to cover a display device (not shown). Herein, pixels (not shown) of the touch panel 62 may be lattices corresponding to pixels of the display device. For example, the pixels of the touch panel and display device may have one-to-one correspondence. The pixels may be imaginary or physical pixels for determining a user's touch points.

The touch panel 62 is not restricted to a specific shape. Namely, the shape of the touch panel 62 does not depend on the locations of the light receiving and emitting units, because the optical T/R modules 61, each of which includes both the light emitting unit 61a and the light receiving unit 61b overlapping each other as shown in FIG. 7, are arranged corresponding to all or some edge pixels of the touch panel 62. Further, when the touch panel 62 has a circular or other polygonal shapes, it does not restrict or limit the location of the optical T/R modules 61, thereby ensuring freedom in design of the optical recognition user input device. Further, since the optical T/R modules including the light emitting and receiving units can be disposed at all sides of the touch panel, light can be emitted from all sides of the touch panel and light reception may also be checked at all sides of the touch panel, unlike the case where the light emitting units or the light receiving units are arranged on some sides of the touch panel. In other words, according to one embodiment of the present invention, since touch points are recognized with the light emitting and receiving units arranged at all sides of the touch panel, the optical recognition user input device may compensate for variation of reception sensitivity according to the locations of the light emitting and receiving units. Thus, recognition efficiency may be improved.

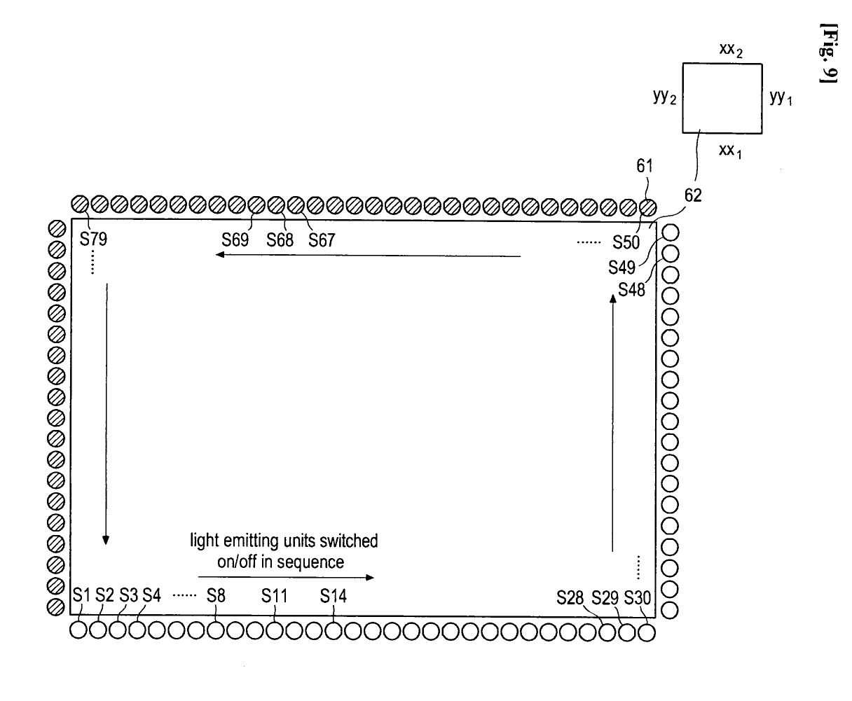

Comparing to the conventional optical recognition user input device, in which a single light emitting unit and a single light receiving unit are separately disposed around the touch panel, that is, where the single light emitting unit and the single light receiving unit are not overlapping with each other, an optical user input device of an embodiment of the present invention has a thicker optical T/R module 61 configured with the light emitting unit 61a and the light receiving unit 61b overlapping each other. That is, it seems that the optical T/R module 61 is thicker than the single light emitting unit or the single light receiving unit by the thickness of the light receiving unit 61b or the light emitting unit 61a. However, when the light emitting unit 61a and the light receiving unit 61b are stacked within a single housing, individual housings of the light emitting unit 61 and the light receiving units 61b can be eliminated to allow a decrease of height by the thickness of the individual housing, thereby reducing such a thickness difference. Further, by taking into consideration the height variation resulting from stacking the light emitting and receiving units 61a and 61b, the optical T/R modules 61 facing each other at the opposite sides of the touch panel 62 may have a different stack order. In more detail, as shown in FIG. 9, the light emitting and receiving units of the optical T/R modules arranged in xx1 and yy1 sides of the touch panel 62 may be stacked inverse to the light emitting and receiving units of the optical T/R modules arranged in xx2 and yy2, facing the sides xx1 and yy1. Thus, the light emitting unit of the optical T/R modules at sides xx1 and yy1 and the light receiving unit of the other optical T/R module xx2 and yy2 can be arranged at an identical height, thereby improving light receiving efficiency.

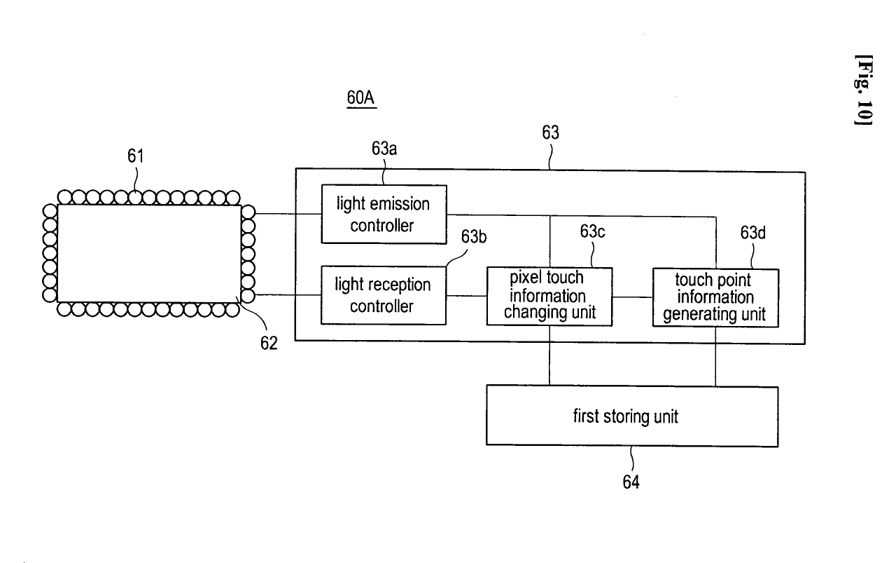

FIGS. 10 to 12 are schematic views of an optical recognition user input device according to one embodiment of the present invention. A controller 63 of an optical recognition user input device 60A, 60B or 60C may output a light emission enable signal and a light reception enable signal for individually enabling and controlling the light emitting units 61a and light receiving units 61b of the respective optical T/R modules 61. The controller 63 may calculate a user touch location on the touch panel 62 based on whether the light receiving units receive the optical signal.

A light emission controller 63a outputs the light emission enable signal for enabling the light emitting units 61a of all of the optical T/R modules 61 for a first preset time according to a predetermined sequence or in a first pattern. Herein, the term “in sequence” means that the light emitting units 61a of the optical T/R modules 61, for example, the light emitting units of the T/R modules at locations S1 to S30 shown in FIG. 8, are sequentially enabled one-by-one. The first pattern means an enabling order of the light emitting units. For example, according to the first pattern, the light emission controller 63a may enable the light emitting units of the optical T/R modules 61 disposed at locations S1, S30, S50, and S79 one-by-one or may enable the light emitting units of the optical T/R modules 61 disposed at locations S1 and S30 at a time. Accordingly, the first pattern can be freely determined by a designer of the device. When setting the first pattern, the light emitting units of the optical T/R modules 61 facing each other at the opposite sides of the touch panel 62 may be controlled to be simultaneously enabled and emit light. Further, the light emitting units of two or more optical T/R modules 61 located on opposite sides (for example, xx1 and xx2) may be controlled to be simultaneously enabled and to emit light. Among the two or more optical T/R modules 61, one of the optical T/R modules may be separated from the other(s) by a half length of one side (that is, xx1), where the one optical T/R module is located.

The light emission controller 63a may permit a light emitting voltage to be supplied to the enabled light emitting unit 61a as the light emission signal such that the optical signal is emitted from the light emitting unit 61a. Light, for example, IR light, is emitted from at least one enabled light emitting unit 61a for the first preset time under the of the light emission controller 63a, is then shut off after the first preset time.

A light reception controller 63b may output the light reception enable signal for enabling all or some of the optical T/R modules 61 for a second preset time. The light reception controller 63b may receive a signal, that is, a light reception signal, for determining whether light is received or not, from at least one enabled light receiving unit 61b in sequence or at the same time. When the optical signal is emitted from a optical T/R module 61, the light reception controller 63b may enable the light receiving units of all or some of the optical T/R modules 61 in sequence or in a second pattern except for the first optical T/R module and may determine light reception of the light receiving units of the respective optical T/R modules 61, having the enabled light emitting units 61b. Herein, the term “in sequence” means that the light receiving units 61b of the adjacent optical T/R modules 61, for example the optical T/R modules at adjacent locations S1, S2 and S3 shown in FIG. 8, are sequentially enabled one-by-one. The second pattern is an enable order of the light receiving units 61b of the optical T/R modules. According to the second pattern, the light receiving units may be enabled one-by-one or simultaneously. For example, the light reception controller 63b may enables the light receiving units 61b of the optical T/R modules 61 disposed at adjacent locations S67, S68, and S69 one-by-one, or may enable the light receiving units 61b of the optical T/R modules 61 disposed at locations S1 to S4 simultaneously. Accordingly, the second pattern can also be freely determined by a designer of the device.

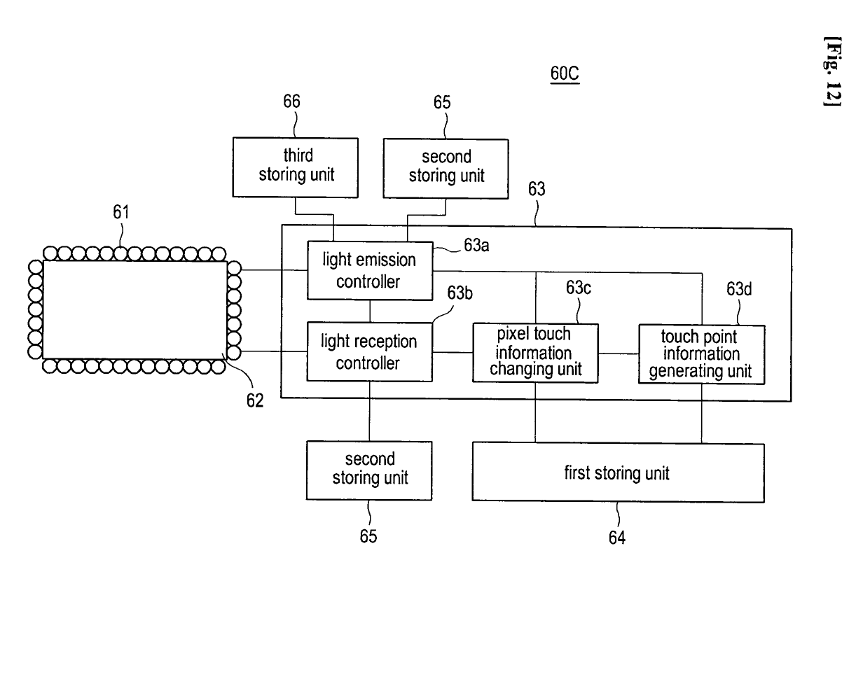

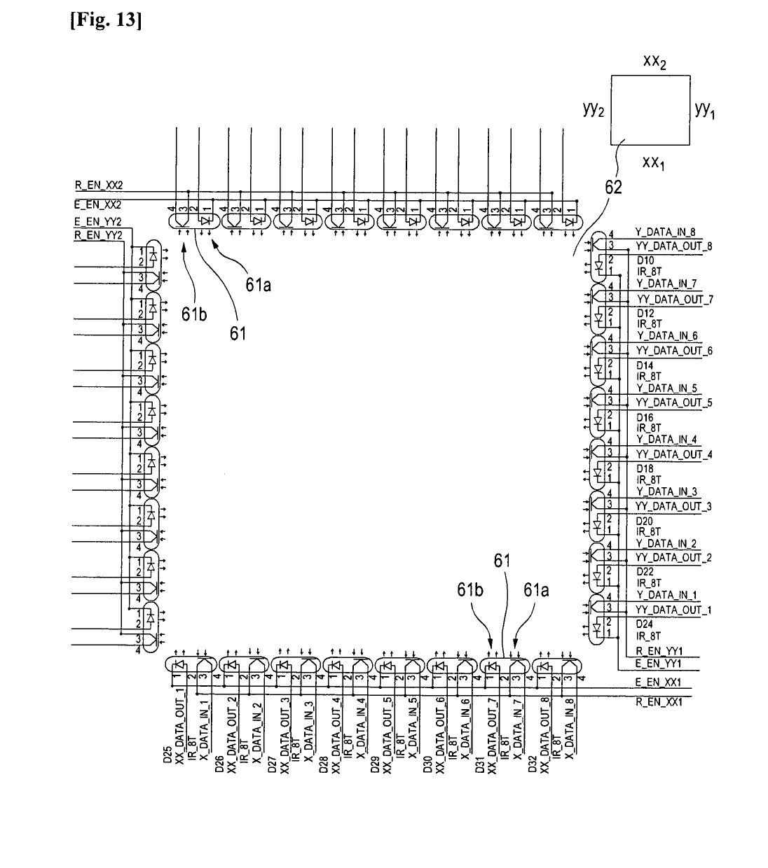

FIG. 13 shows a data line configuration of the light emitting units 61a and the light receiving units 61b of the plural optical T/R modules 61 arranged along the edge of the touch panel 62. When the plural optical T/R modules 61 are arranged along four sides xx1, yy1, xx2 and yy2 of the rectangular touch panel 62, transmission lines for light reception enable signals R_EN_XX1, R_EN_YY1, R_EN_XX2, and R_EN_YY2 and transmission lines for light emission enable signals E_EN_XX1, E_EN_YY1, E_EN_XX2, and E_EN_YY2 are provided to all the sides xx1, yy1, xx2 and yy2. In one embodiment, the optical T/R modules 61 disposed on the same side may share the same transmission lines for the light reception enable signals and the light emission enable signals.

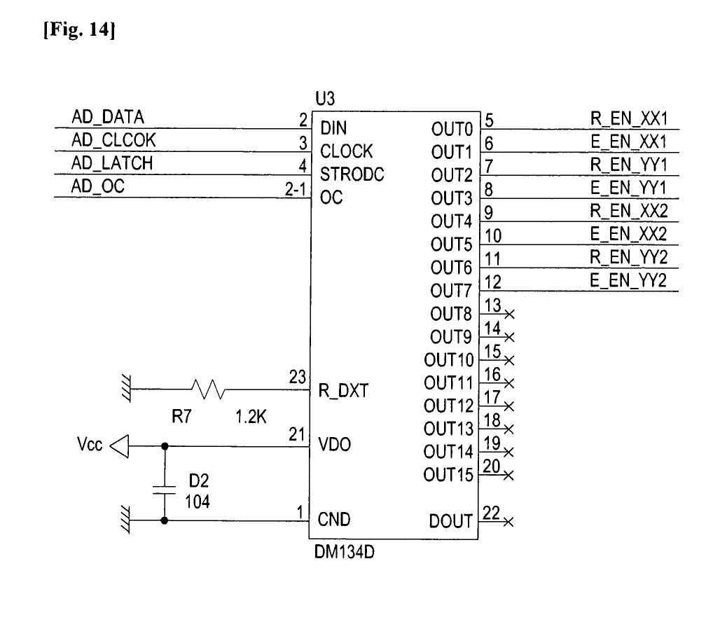

FIG. 14 shows signal input/output of the controller 63 that supplies the light reception enable signals R_EN_XX1, R_EN_YY1, R_EN_XX2, and R_EN_YY2 and the light emission-enable signals E_EN_XX1, E_EN_YY1, E_EN_XX2, and E_EN_YY2. In one embodiment, a light emission enable signal R_EN_XX1, R_EN_YY1, R_EN_XX2 or R_EN_YY2 output from the light emission controller 63a of FIGS. 10 to 12 may be input to the light emitting unit 61a via the data line 1 of FIG. 7. The light emission signal output from the light emission controller 63a may be input to the light emitting unit 61a via the data line 2. In one embodiment, the light emission controller 63a of FIGS. 10 to 12 may be configured with a bidirectional buffer (74HC245), a dual P-channel enhancement mode field effect Transistor (CEM4953A) and so on to generate the light emission signal from a supply power Vcc, as shown in FIG. 15.

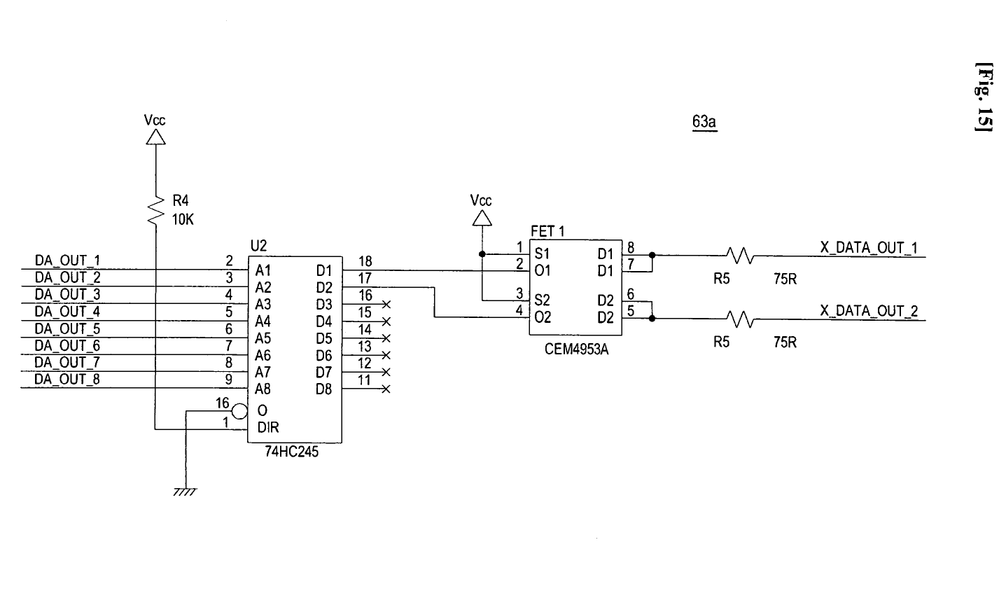

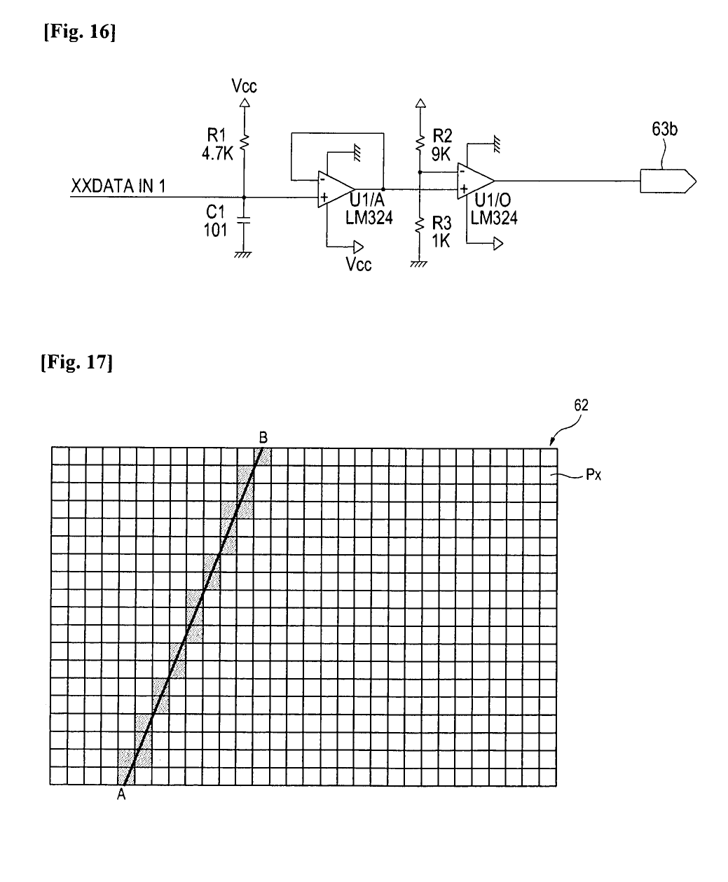

Referring again to FIGS. 7 to 13, in one embodiment, when a light reception enable signal R_EN_XX1, R_EN_YY1, R_EN_XX2, or R_EN_YY2 output from the light reception controller 63b is input to the light receiving unit 61b via the data line 2 and the enabled light receiving unit 61b receives the optical signal, the optical signal may be converted into an electrical light reception signal, which in turn is input to the light reception controller 63b via the data line 4. In one embodiment, the optical signal may be amplified by operation amplifiers configured with LM324 and so on, and then reach the light reception controller 63b as shown in FIG. 16.

In one embodiment of the invention, the light emitting units and the receiving units of the optical T/R modules disposed corresponding to the edge pixels of the touch panel (for example, one-to-one correspondence) may be enabled at least one-by-one. The light reception of the light receiving units overlapped with the light emitting unit may detect the light reception at least one-by-one to determine the existence of the touch point. Thus, even when a certain light emitting unit or light receiving unit malfunctions, there is no significant influence on recognition of the touch point.

Referring again to FIGS. 10 to 12, which shows the optical recognition user input devices 60A, 60B and 60C, a pixel-touch information changing unit 63c of the controller 63 may set an imaginary straight line linking a first optical T/R module, which is designated in sequence to output light, to a second optical T/R module, which receives the optical signal (light), and may create information of whether pixels on the imaginary straight line are touched.

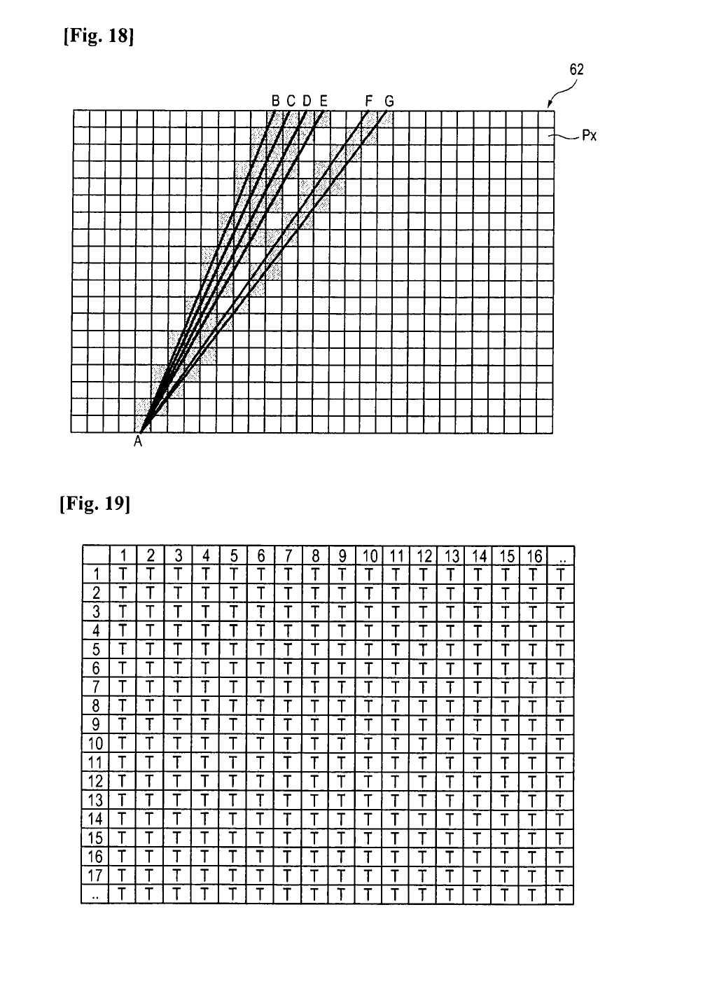

Assuming that the light (optical signal) is emitted from a first optical T/R module and the optical signal is received at a second optical T/R module, it may be determined that there is no touch point (obstacle) on pixels of the imaginary straight line between the first and second optical T/R modules. For example, referring to FIG. 17, if light emitted from the light emitting unit of the first optical T/R module at position A of the touch panel 62, having a plurality of pixels Px, is received by the light receiving unit of the second optical T/R module at position B, it is determined that there is no touch point on the pixels on an imaginary straight line linking the position A and location B. In another example, referring to FIG. 18, if light emitted from the first optical T/R module at location A is received by the light receiving units of the second optical T/R modules at locations B, C, D, E, F, and G, it is determined that there is no touch point on the pixels on imaginary straight lines linking A to B, C, D, E, F, and G, respectively. In this manner, when scanning with the respective optical T/R modules arranged along all edges of the touch panel, the existence of an obstacle (a touch point) may be confirmed several times with respect to a single pixel. Therefore, even in the case where the reception intensity is low, the existence of the touch on each pixel can be accurately determined with the light received by other adjacent optical T/R modules.

A first storing unit 64, shown in FIG. 10, may have a plurality of storage sections corresponding to the pixels (one-to-one correspondence) to store pixel touch information of the respective pixels. The first storing unit 64 may be configured with a pixel touch information table as shown in FIG. 19.

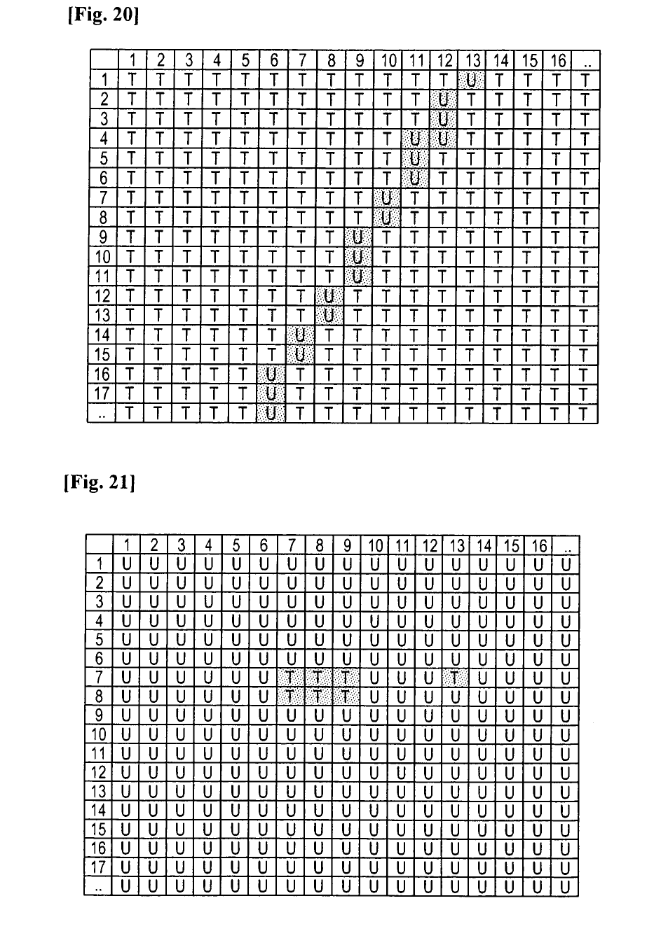

In one embodiment, data of all pixels in an initial state may be set to initial information (default value) T. In other words, all of the pixels may be initially set as being touched. While enabling the light emitting units 61b of optical T/R modules 61 in sequence (or in first pattern) and determining whether the optical signal is received at the light receiving units 61b of the respective optical T/R modules 61, the first storing unit 64 may receive pixel un-touch information U of the pixels on the imaginary straight line linking the first optical T/R module and the second optical T/R module, from the pixel touch information changing unit 63c. The pixel un-touch information U may be reflected in the pixel touch information table as depicted in FIG. 20. Preferably, the pixel-touch information changing unit 63c may select the pixel having the initial information T among the pixels on the imaginary straight line and may change the initial information T to the pixel un-touch information U. FIG. 21 shows information of the first storing unit 64 when the process of enabling the light emitting and receiving units 61a of all the optical T/R modules 61 is completed.

In one embodiment, for the pixel having the pixel touch information remaining as the initial information T after the process of enabling all of the light emitting and receiving units, it is determined that there is at least one touch point. A touch point information generating unit 63d of the controller 63 may generate information of at least one user touch point from positional information of at least one pixel, where the pixel touch information is not changed, in the first storing unit 64.

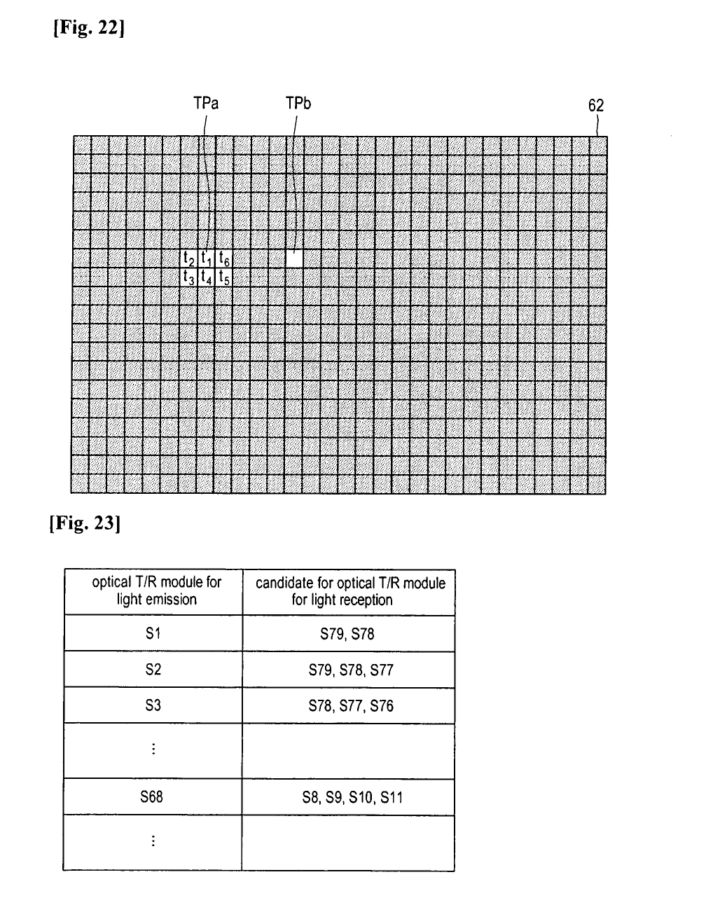

FIG. 22 shows locations of two touch points TPa and TPb on the touch panel 62 obtained by generating the touch point information of the pixels where the pixel-touch information is not changed. In this manner, it is possible to simultaneously calculate two or more touch points touched by the user on the touch panel 62. In one embodiment, the touch points may be a convex hull of various shapes expressed by a plurality of pixels or a line expressing a touch trace (t₁-t₂-t₃-t₄-t₅-t₆) of a user. The pixels constituting the touch points can be pixels that are simultaneously or sequentially touched by the user.

In the embodiments, a difference in reception intensity does not substantially affect the recognition of the touch point since the touch point may be recognized by sequentially removing from interest, based on the pixel touch information table, the pixels on the imaginary straight line between the first optical T/R module emitting light and the second optical T/R module receiving the light. In other words, according to the conventional technique, if the light receiving unit fails to receive light, it is determined that there is a touch point on the pixels between the associated light emitting unit and the light receiving unit. Accordingly, reliability of detection capability is affected by the difference in reception intensity. In the embodiment of the present invention, however, the pixels determined as one having not been touched are removed from interest, and, the location of the touch point is determined with a remaining pixel that is not finally removed when light emission of all the optical T/R modules is completed. As a result, it is possible to prevent an error in recognition of the touch point and to improve detection capability of the optical recognition user input device.

The light receiving unit may determine the reception of light when the light having a critical intensity or more is received. Thus, it is desirable to assume that the optical T/R modules adjacent to the first optical T/R module emitting light do not receive the light. For example, referring again to FIG. 8, when the optical T/R module at location S11 is designated as the first optical T/R and an optical signal is output therefrom, optical T/R modules at locations S8 to S14, which are apart from the first optical T/R module at location 8, can receive the optical signal. However, it is more important whether the optical T/R modules at and around location S68, which facing the optical signal output from the optical T/R module at location 8, receive the optical signal to determine the existence of a touch point (obstacle) on the touch panel 62. Since the light receiving units of the second optical T/R modules at locations S8 to S14 are likely to receive the light irrespective of the existence of the obstacle, it is desirable that the light reception of the optical T/R modules within a predetermined distance from the first optical T/R module, not be taken into consideration.

Referring to FIG. 11, the optical recognition user input device 60B may include all components of the device 60A of FIG. 10, and may further include a second storing unit 65 for storing identification information of at least one candidate for a second optical T/R module. The “candidate” means optical T/R modules, which are capable of receiving the optical signal output from another optical T/R module designated as the first optical T/R module and to which the reception of the optical signal is meaningful. Thus, the candidate for the second optical T/R module may be preset with the optical T/R modules disposed at a location where the optical T/R modules can receive the light, emitted from the first optical T/R module designated by the light emission controller 63a, with a critical intensity or more. The candidate for the second T/R module may be preset based on an experimental result or positional relations among the optical T/R modules. One designated first T/R module may have at least one candidate of the second optical T/R module, which located at the opposite side of the touch panel to face the first T/R module.

The second storing unit 65 may store a table that lists locations of the optical T/R module for light emission (the first optical T/R module) and the candidates for the optical T/R module for light reception (the second optical T/R module) as shown in FIG. 23. The number of candidates for the second optical T/R module may be at least one. According to one embodiment, the light emission controller 63a may control the light emitting units 61a of the optical T/R modules 61 to emit light in sequence or in the first predetermined pattern, which can be determined from a sequence of the first optical T/R modules stored in the second storing unit 65. Further, in one embodiment, when an optical signal is emitted from the first optical T/R module, the light reception controller 63b individually or simultaneously may enable the light receiving units of all or some of the optical T/R modules in sequence or in the second pattern except for the first optical T/R module to determine light reception of the light receiving units. The second pattern can be determined from positional information of the candidates for the second optical T/R module with respect to the respective first optical T/R modules stored in the second storing unit 65. The candidates for the second optical T/R module may also be updated by accumulating the positional information of the second optical T/R modules, which receive the light from the designated first optical T/R module, in the second storing unit 65 while repetitively operating the optical recognition user input device.

The optical recognition user input device having the second storing unit 65 can reduce scanning time by determining the reception of light only with respect to the second optical T/R modules without determining the reception of light with respect to all of the optical T/R modules except for the first optical T/R module. For the optical recognition user input device, in which precision is of the utmost importance, that is, for the optical recognition user input device which determines the reception of light at the respective light receiving units of all the optical T/R modules, the second storing unit can be omitted.

In the device having the second storing 65 for storing the candidates for the second optical T/R module, at least two first optical T/R modules 61 may be designated to further reduce the scan time. In this case, it is desirable that different first optical T/R modules 61 may be associated with different candidates of the second optical T/R module 61. For example, in FIG. 8, the optical T/R modules 61 at locations S1 and S68, arranged at the opposite sides of the touch panel 62 to face each other, may be designated as the first optical T/R modules for light emission, since the two first optical T/R modules have different candidates for the second optical T/R modules. Like this, two or more optical T/R modules can be designated as the first optical T/R modules at the same time, and the reception of light can be determined with respect to the candidates for the second optical T/R module for the associated first optical T/R modules, thereby reducing the scanning time.

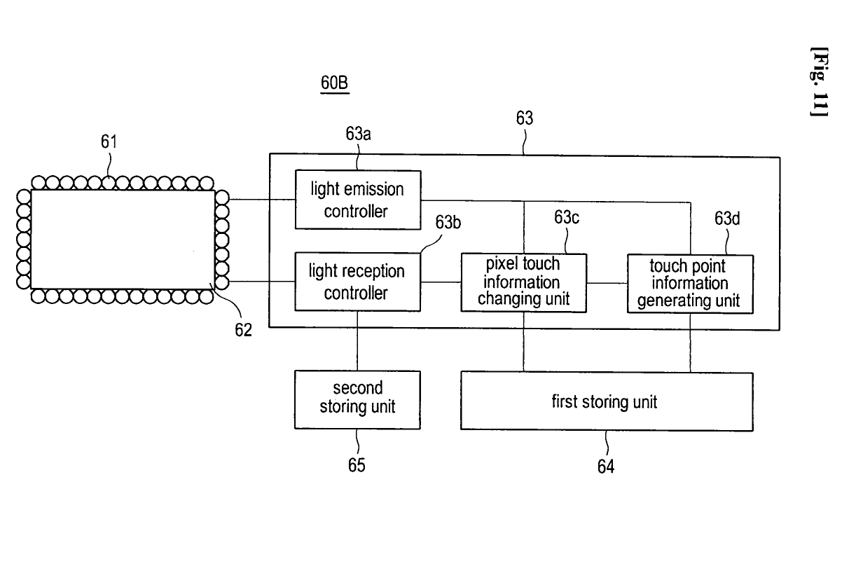

Referring to FIG. 12, according to a further embodiment of the present invention, the optical recognition user input device 60C includes all components of the device 60B shown in FIG. 8b, and may further include a third storing unit 66 for storing information as to whether the respective optical T/R modules emit light. That is, the third storing unit 66 stores information as to whether a certain optical T/R module is designated as the first optical T/R module. In the device 60C, the light emission controller 63a may further have a function of searching the optical T/R modules, of which all of the second optical T/R module(s) are not identical, in the second storing unit 65. The light emission controller 63a may select the optical T/R modules, which have not been previously designated as the first optical T/R module among the searched optical T/R modules, with reference to the third storing 66. At least some of the selected optical T/R modules are designated as the first optical T/R modules and first optical T/R module designation information is created and input to the third storing 66 and the light reception controller 63b. All of the light emitting units of the first optical T/R modules can emit light at the same time under the control of light emission controller 63a.

The light reception controller 63b may receive the first optical T/R module designation information sent from the light emission controller 63a, and may determine whether light is received by the candidates for the second optical T/R module, which correspond to the first optical T/R modules, to create information of the second optical T/R module.

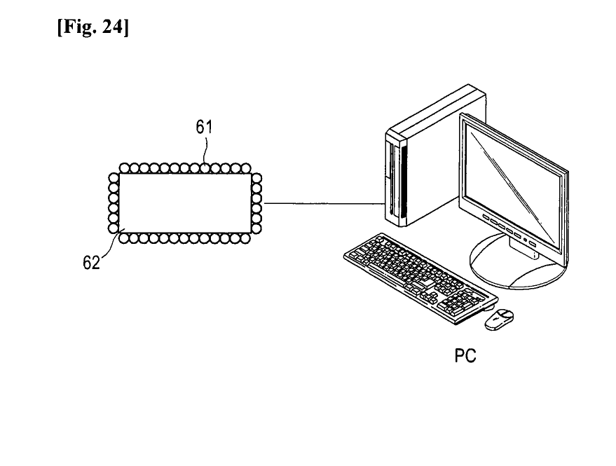

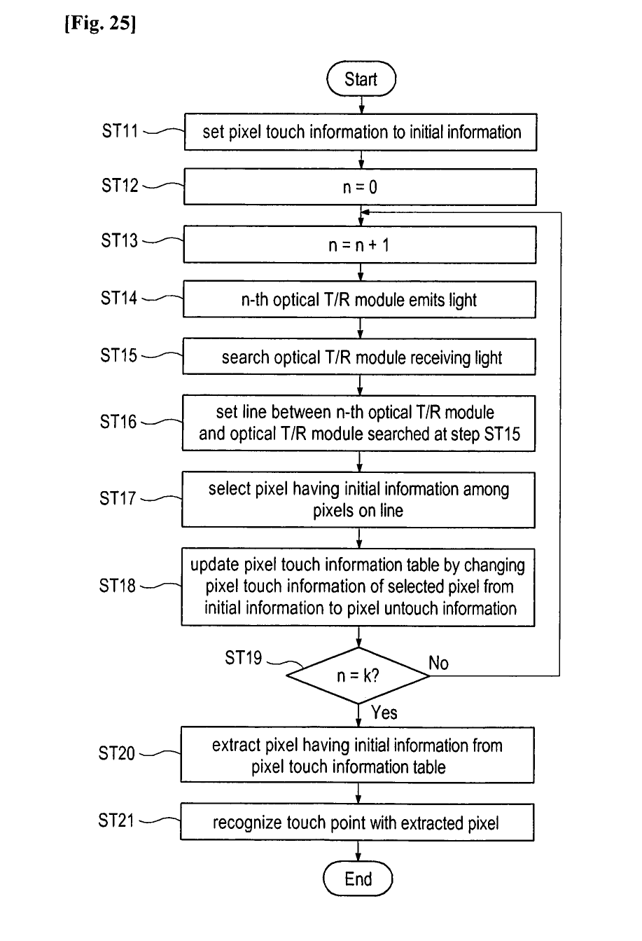

FIG. 24 shows the touch panel 62 and the optical T/R modules 61 connected to a personal computer (PC) according to one embodiment of the invention. In this embodiment, a central processing unit (CPU) of the PC may act as the controller 63 of FIGS. 10 to 12, and volatile memory of the PC may act as the first storing unit 64. The second storing 65 may be configured with the volatile memory for the device to update the candidates for the second optical T/R module. In the case of presetting the candidates for manufacturing the device, the second storing unit 65 may be configured with non-volatile memory.

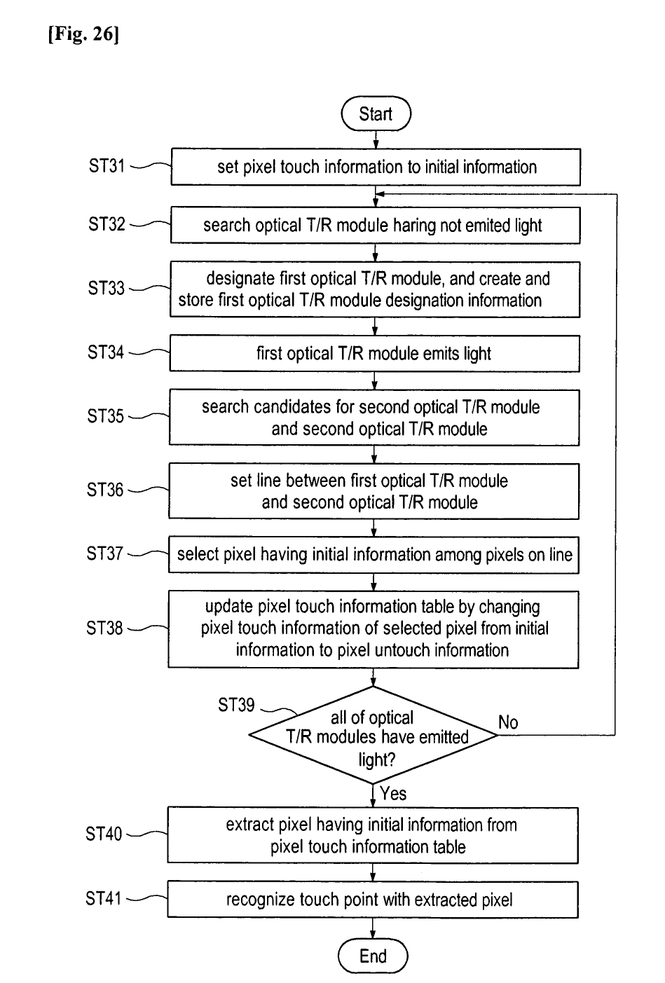

Referring to FIG. 25, showing a flow chare of a method for recognizing a touch point with the optical recognition user input device according to one embodiment of the present invention, in an initialized state of touch point recognition, all storage sections of the first storing unit (pixel touch information table) is set to initial information T, as shown in FIG. 19 (ST11), and a variable “n” indicating a light emission sequence is initialized (ST12). When an optical T/R module is designated as the first optical T/R module, the variable n is increased by 1 (ST13). A light emitting unit of an n-th optical T/R module is controlled to emit light (ST14). Then, light receiving units of all optical T/R modules or some selected optical T/R modules (candidates for a second optical T/R module) are sequentially or simultaneously enabled except for the n-th optical T/R module (ST15), and the enabled light receiving units having received the light emitted from the n-th optical T/R module are searched. An imaginary straight line linking the n-th optical T/R module and the searched optical T/R module (second optical T/R module) is set (ST16), and a pixel having the initial information is selected among the pixels on the imaginary straight line (ST17). The pixel touch information table is updated by changing data of the selected pixel from the initial information to pixel untouch information, as shown in FIG. 20 (ST18). Then, it is determined whether all of the optical T/R modules have been designated as the first optical T/R module (ST19). In FIG. 25, “‘k” may denote total number the optical T/R modules. If all of the optical T/R modules have been designated as the first optical, any pixel maintaining the initial information T without be changed to the un-touch information is extracted from the finally updated pixel touch information table shown in FIG. 21 (ST20). Then, a touch point or a convex hull, configured with plural touch points, is recognized from the extracted pixels on the touch panel as shown in FIG. 22 (ST21). In other words, location of the touch point is calculated.

Referring to FIG. 26, showing a flowchart of a method for recognizing a touch point with the optical recognition user input device 60C of FIG. 12, in an initialized state of touch point recognition, all storage sections of the first storing unit (pixel touch information table) is set to initial information T as shown in FIG. 19 (ST31), and optical T/R modules which do not emit light, that is, which have not been designated as the first optical T/R module, are searched in the third storing 66 (ST32). Then, at least one optical T/R module is selected from the searched optical T/R modules and designated as the first optical T/R module; and first optical T/R module designation information is created and stored in the third storing unit (ST33). The first optical T/R module is controlled to emit light (ST34). After searching candidates for the second optical T/R module corresponding to the designated first optical T/R module, light receiving units of the candidates are sequentially or simultaneously enabled, and the second optical T/R modules receiving the light emitted from the first optical T/R module are searched (ST35). An imaginary straight line between at least one first optical T/R module and at least one second optical T/R module is set (S36), and a pixel having the initial information is selected among the pixels on the imaginary straight line (ST37). The pixel touch information table is updated by changing touch information of the selected pixel from the initial information to pixel un-touch information, as shown in FIG. 19 (ST38). Then, it is determined whether all of the optical T/R modules have been designated as the first optical T/R module by determining whether all of the optical T/R modules have been designated as the first optical modules referring to the third storing unit (ST39). If yes, any pixel maintaining the initial information T without being changed to the un-touch information is extracted from the finally updated pixel touch information table shown in FIG. 21 (ST40). Then, at least one touch point on the touch panel is recognized from the extracted pixels as shown in FIG. 22 (ST41). In other words, location of the touch point is calculated.

Any reference in this specification to one embodiment, an embodiment, example embodiment, etc. means that a particular feature, structure or characteristic described in connection with the embodiment is included in at least one embodiment of the present invention. The appearances of such phrases in various places in the specification are not necessarily all referring to the same embodiment. Further, when a particular feature, structure or characteristic is described in connection with any embodiment, it is submitted that it is within the purview of one skilled in the art to effect such feature, structure or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, numerous variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### INDUSTRIAL APPLICABILITY

The present invention may be utilized in recognizing one or more user input.

1. An optical recognition user input device comprising:
a touch panel including a plurality of pixels;
a plurality of optical transmission/reception (T/R) modules disposed around the touch panel, wherein each of the optical T/R modules includes a light emitting unit and a light receiving unit; and
a controller configured to control operation of the plurality of optical T/R modules and to calculate a user touch location on the touch panel based on an optical signal received by the light receiving unit.

2. The optical recognition user input device of claim 1, wherein the controller includes:
a light emission controller configured to control the light emitting units of the plurality of the optical T/R modules in sequence or in a predetermined pattern; and
a light reception controller configured to control the light receiving units corresponding to the light emitting units to receive the optical signals from the light emitting units.

3. The optical recognition user input device of claim 1, further comprising:
a first storing unit configured to store information of whether each of the plurality of pixels of the touch panel is touched by a user.

4. The optical recognition user input device of claim 3, wherein the controller further includes:
a pixel touch information changing unit configured to set a default value of the information in the first storing unit and to change the default value of the information of the pixels on an imaginary line between the light emitting unit and the light receiving unit receiving the optical signal emitted from the light emitting unit in the first storing unit; and
a touch point information generating unit configured to calculate the user touch location from the information of the pixels in the first storing unit.

5. The optical recognition user input device of claim 1, further comprising:
a second storing unit configured to store information to discriminate at least one light receiving unit corresponding to the light emitting unit included in one of the optical T/R modules.

6. The optical recognition user input device of claim 5, wherein at least one light receiving units is selected among the receiving units facing to the light emitting unit.

7. The optical recognition user input device of claim 5, wherein the controller controls two or more light emitting units among the plurality of light emitting units to simultaneously enable or disable, and to calculate the user touch location according to whether the light receiving units corresponding to the two or more light emitting units receive the light.

8. The optical recognition user input device of claim 1, wherein the light emitting unit and the light receiving unit of each of the optical T/R modules are independently operated.

9. The optical recognition user input device of claim 1, wherein the light emitting unit and the light receiving unit of the optical T/R module are disposed to overlap each other in an up and down direction.

10. The optical recognition user input device of claim 1, wherein the light emitting unit and the light receiving unit of the optical T/R module are formed to constitute an integral structure.

11. The optical recognition user input device of claim 1, wherein each of the optical T/R modules is disposed corresponding to each of edge pixels of the touch panel.

12. An optical recognition user input device comprising:
a touch panel comprising a plurality of pixels; and
a plurality of optical T/R modules disposed around the touch panel,
wherein each of the optical T/R modules includes a light emitting unit and a light receiving unit, the light emitting unit and the light receiving unit of each of the optical T/R modules being overlapped each other in an up and down direction and operated independently of each other.

13. The optical recognition user input device of claim 12, wherein the touch panel has a circular or polygonal shape.

14. The optical recognition user input device of claim 12, wherein the optical T/R modules facing each other have an inverse arrangement of the light emitting unit and the light receiving unit.

15. The optical recognition user input device of claim 12, wherein the optical T/R modules are operated to allow the light emitting units of a designated number of the optical T/R modules to emit light at the same time.

16. The optical recognition user input device of claim 12, wherein the light emitting unit and the light receiving unit of each of the optical T/R modules share a power line.

17. A method of recognizing user input using an optical recognition device comprising light emitting units and light receiving units, the method comprising:
controlling the light emitting units in sequence or in a predetermined pattern, and
controlling operation of the light receiving units corresponding to the light emitting units; and
calculating a user input location based on receiving signals sent from the light receiving units.

18. The method of claim 17, wherein the controlling step include controlling the light emitting units in sequence, and controlling all of the light receiving units to receive signals.

19. The method of claim 17, wherein the controlling step includes controlling the light emitting units in sequence by two or more at a time, and controlling the light receiving units corresponding to the respective light emitting units to receive signals.

20. The method of claim 19, wherein the two or more light emitting units emitting light at the same time are present on opposite sides, one of the two or more light emitting units apart from the other light emitting units by a predetermined distance, wherein the predetermined distance is half of a length of the side where the one light emitting unit is present.

21. The method of claim 19, wherein the two or more light emitting units have different sets of the light receiving units.

22. The method of claim 17, wherein the controlling step includes controlling the light emitting units in sequence by three or more at a time, and controlling the different light receiving units to receive signals from respectively corresponding light emitting units.

23. The method of claim 17, wherein the calculating step includes: initializing information of respective pixels of a touch panel; receiving the user input; and changing the information of the respective pixels based on the signals from the light receiving units.

24. A method of recognizing user input using an optical recognition device comprising light emitting units and light receiving units, the method comprising:
setting information of respective pixels of a touch panel receiving the user input to an initial value;
changing the information of the respective pixels of the touch panel based on input signals from the light receiving units of the optical recognition device; and
calculating a user input location based on the information of the respective pixels of the touch panel.

25. The method of claim 24, wherein the initial value is information indicating that the pixels of the touch panel are selected by a user.

26. The method of claim 25, wherein the changing step includes: changing information of the pixels on an imaginary line between the light receiving unit receiving light and the light emitting unit corresponding to the light receiving unit.

27. The method of claim 24, wherein the calculating step includes calculating two or more user input locations on the touch panel when two or more user inputs are performed at the same time.

28. The method of claim 24, wherein the calculating step includes calculating user input locations according to sequential touch inputs on the touch panel by a user, the sequential inputs being recognized as a specific figure or motion.
